(19) United States
(12) Patent Application Publication
(10) Pub. No.: US 2023/0306346 A1
(43) Pub. Date: Sep. 28, 2023

(54) INTEGRATING SYSTEM FOR EVALUATING AND MANAGING CULTIVATION AND TARGETED ADOPTION

(71) Applicants: Wan-Zhou YU, Yilan County (TW); Ting-Yu CHEN, Yilan County (TW); Hsuan-Chung HUANG, Yilan County (TW); Shun-Qing ZHANG, Yilan County (TW); Yen-Chun TUNG, Yilan County (TW)

(72) Inventors: Wan-Zhou YU, Yilan County (TW); Ting-Yu CHEN, Yilan County (TW); Hsuan-Chung HUANG, Yilan County (TW); Shun-Qing ZHANG, Yilan County (TW); Yen-Chun TUNG, Yilan County (TW)

(21) Appl. No.: 17/702,852

(22) Filed: Mar. 24, 2022

(51) Int. Cl. G06Q 10/06; G06Q 30/02; G06Q 50/02

(52) U.S. Cl. CPC G06Q 10/06375; G06Q 30/0201; G06Q 30/0206; G06Q 50/02

(57) ABSTRACT

Aan integrating system for evaluating and managing cultivation and targeted adoption includes a cultivating adoption evaluating and managing system, a profit returning module, and a contract terminating, rescinding and assigning module; the cultivating adoption evaluating and managing system includes, an adoption confirming system, a cultivating data and harvesting database, a contract database; the adoption confirming system includes, an adoption reporting evaluating procedure module, a contract concluding procedure module; the adoption reporting evaluating procedure module is connected to the adoption buying proposing module; with the system, an automatic solution is provided to the adoption contract, the procedure of the contract drafting to the contract signing can be processed online for establishing the filing operation; the purchasing price in the market and the profit statuses of both parties can be obtained in any desired time for the investing party and the cultivating party.

### BACKGROUND OF THE INVENTION

### 1. Field of the Invention

The present invention relates to a system, especially to an integrating system for evaluating and managing cultivation and targeted adoption.

### 2. Description of Related Art

According to the market trend in the cultivating industry, there are more and more kinds of cultivating creatures and improved breeds, thus the whole market scope has been greatly expanded; under this market trend, more individual investors and companies want to be involved in the cultivating industry or invest in the cultivating industry for gaining more profit besides his/her own business; however, investing in the cultivating industry has a feature of capital entry barrier, and a large amount of money have to be invested in the initial stage for the purpose of entering the cultivating industry. As such, a company with less capital or an individual investor is not able to enter the cultivating industry for investment, the aforesaid issue is the current problem facing by the cultivating industry, on the other hand, for expanding the business scale of the cultivating industry, expanding the size of the cultivating farm and purchasing equipment to make more profit, the requirement for the external capital to be inputted is more needed; in the conventional cultivating industry, a great amount of money has to be invested because of external factors (for example weather, insect pests and over production), and the profit is hard to be estimated, thus an negative affection may be considered by the capital party who is interested in investing the cultivating industry, and the capital founding is hard to success; based on what has been disclosed above, there are more issues regarding to the investment and the capital flow in the cultivating industry, which are as follows: 1. the cultivating farm needs capital to expand the business scale and maintain the cash flow; 2. there may be a major differentiation between the purchasing price and the market price; 3. the cultivating farm does not know how and where to find the capital founding; 4. the local cultivating industry is hard to draw the attentions of foreign capital; and 5. the capital party does not know which cultivating industry or products being suitable targets to be invested.

Accordingly, a cultivating adoption evaluating and managing system, a profit returning module, a return on investment estimating system of the cultivating farm, a public platform of the purchasing price and the harvesting status, and a purchasing platform of the adopted creature are required. As such, the practicability is very much limited and shall be concerned and improved by the skilled people in the art and the customers.

### SUMMARY OF THE INVENTION

For solving the shortages existed in the prior arts, one primary objective of the present invention is to provide an integrating system for evaluating and managing cultivation and targeted adoption, the system 1000 includes a cultivating adoption evaluating and managing system 1, a profit returning module 2, a contract terminating, rescinding and assigning module 3; the cultivating adoption evaluating and managing system 1 includes, but not limits to, an adoption confirming system 11, a cultivating data and harvesting database 1111, a contract database 1121; the adoption confirming system 11 includes, but not limits to, an adoption reporting evaluating procedure module 111 and a contract concluding procedure module 112; the adoption reporting evaluating procedure module 111 is connected to the adoption buying proposing module 10; the contract concluding procedure module 112 is connected to the profit returning module 2; the adoption confirming system 11 allowing the contract to be terminated or assigned earlier than the contracted period is connected to the contract terminating, rescinding and assigning module 3, and the profit returning module 2 providing the adopting amount and money based on the signed contract is connected to the contract terminating, rescinding and assigning module 3; thereby solving the shortages existed in the prior arts.

Another objective of the present invention is to provide an integrating system for evaluating and managing cultivation and targeted adoption, in which a user applies for the adoption offer (subscribe) and provides the personal data and identification and the financial statement, then the user is allowed to select the cultivating farm or the cultivating creature available to be adopted and finishes the contract signing process; after the contract is concluded, the user is allowed to enter the profit returning module 2 to get the production profit or sharing listed in the contract; after the contract target has achieved or the contract has to be rescinded due to other factors, the contract would be transferred to the contract terminating, rescinding and assigning module 3 for terminating or rescinding the contract.

Another objective of the present invention is to provide an integrating system for evaluating and managing cultivation and targeted adoption, in which more investing capital can be founded in an easier manner, and an investing and communicating channel can be established, and the purchasing price in the market and the profit statuses of both parties can be obtained in any desired time for the investing party and the cultivating party for increasing the market transparency.

For achieving the aforesaid objective, one technical solution provided by the present invention is to provide an integrating system for evaluating and managing cultivation and targeted adoption, characterized in: the system including a cultivating adoption evaluating and managing system, a profit returning module, and a contract terminating, rescinding and assigning module; wherein the cultivating adoption evaluating and managing system includes, but not limits to, an adoption confirming system, a cultivating data and harvesting database, a contract database; the cultivating adoption evaluating and managing system is to provide an adoption buying proposing module to a user for concluding the contract and signing online, and the signed contract is stored in the system; the adoption confirming system includes, but not limits to, an adoption reporting evaluating procedure module, a contract concluding procedure module; the cultivating data and harvesting database is connected to the adoption reporting evaluating procedure module, the contract database is connected to the contract concluding procedure module, and the adoption reporting evaluating procedure module is connected to the adoption buying proposing module; the contract concluding procedure module of the adoption confirming system is connected to the profit returning module; the adoption confirming system allowing the contract to be terminated or assigned earlier than the contracted period is connected to the contract terminating, rescinding and assigning module, and the profit returning module providing the adopting amount and money based on the signed contract is connected to the contract terminating, rescinding and assigning module; the profit returning module is that after the user gets the official adoption contract and has the module of getting profit source; the profit returning module includes, but not limits to, a real time profit calculating module, a profit paying procedure module; the adoption buying proposing module is a procedure of data submitting and checking via the system end regarding to the adopted target and the investing budget of the user (an investor) before buying the adopting offer; the data provided by the user includes, but not limits to, the adopting farm code, the target selection of adopted cropper and creature, the investing amount, and the personal or related financial statements; the system works with an image identifying process and an removing the manual inputting data submitted by the user; the adoption reporting evaluating procedure module is used for automatically or allowing the user to select the cultivating farm and the cultivating target with respect to the data provided by the user, and the proposed conditions of the user includes, but not limits to, the investing amount, the estimated profit, the schedule, the initial purchasing cost of equipment and the maintaining cost; after the user confirms the agreed contents, the contract concluding procedure module is used for automatically forming the cultivating farm adopting offer and all the related contracts between the user and the system, and the user is allowed to sign the contract online; the condition for concluding the contract includes, but not limits to, the contracting party, the personal data of investor, the investing amount, the payment day of investing capital, the liquidated damage, the purchasing price and the purchasing amount of the cultivating creature; the contract includes, but not limits to, an adoption contract, a rental contract, an escrow contract and a purchasing contract; after the contract is concluded, an exclusive identifying code of the contract is provided by the system to allow the cultivating creature in the cultivating farm to be tracked according to the identifying code so as to be purchased by the system after the harvest; the cultivating data and harvesting database is used for allowing the system to calculate the data source of the estimated profit of the adoption of the user; the data content includes, but not limits to, all the historical purchasing prices of the adopted cropper, the harvesting amount and the market demand; the contract database is a database stored with all the signed contracts and links the related data; the content and the category of the contract database includes, but not limits to, the signed contract and the content thereof (the content including, but not limiting to, the identifying code of the contract, the effecting time of the contract, the terminating time of the contract, the personal data related to the contract, the contracted target of the cultivating creature, and the contract owner), the user data, and the current status of the contract and the executing status thereof; the real time profit calculating module is to calculate the current estimated profit to the cultivating creature in the system including, but not limiting to, the real time dealing price of the adopted cropper or creature, the negotiated price in the adoption contract and the harvesting amount according to the existing adoption contract; the profit paying procedure module is to pay the money to the user who owns the adoption contract after the cultivating creature in the adoption contract has been cultivated and the system purchases and pays the purchasing price listed in the contract, then the money is paid to the user through the system; the payment method includes, but not limits to, banking transfer, third-party payment, cash, mobile payment, electric payment; the profit returning module includes both of the historical payment records and all the received payment records which the user is able to inquire in the system with respect to the contract at any time; the contract terminating, rescinding and assigning module refers to that after the purchasing amount or price according to the contract has been honored, the contract is terminated or rescinded, the right of managing the cultivating farm is back to the system, a module of providing other users or the previous user who had the adoption contract to propose the adoption; the contract includes, but not limits to, an adoption contract, a rental contract, an escrow contract and the purchasing contract; the contract terminating, rescinding and assigning module is to process actions including, but not limiting to, terminating, rescinding and assigning the contract with respect to conditions and ranges agreed by both parties involved in the contract.

Wherein, the system is connected to a return on investment estimating system of the cultivating farm, the system processes a price evaluation to the price related data of the cultivating creature through the adoption reporting evaluating procedure module of the cultivating adoption evaluating and managing system for serving as an analysis of the estimated return on investment which is able to be provided to the potential customer as a reference data before investing; the data source analyzed by the system includes, but not limits to, the weight of the cultivating creature, the color of the cultivating creature, the size of the cultivating creature, the activity of the cultivating creature, the health of the cultivating creature, the catgut of the cultivating creature, the growing status of the cultivating creature, the cultivating cost, the cultivating successful rate, the cost of the cultivating equipment and the environmental factors; an integrated model of return on investment is established based on the above-mentioned data, and the obtained estimated data is stored in the cultivating data and harvesting database as a reference for potential customer

Wherein, the system is connected to an evaluating system for adoption contract extension; the system is able to automatically provide a new contract with the current reasonable market purchasing price to the contract which is able to be terminated or rescinded according to the contract terminating, rescinding and assigning module, the contract is provided to the user as an extending contract, so that the profit to the user is able to be closer to the market purchasing price, thus any one of the user or the system is prevented from losing profit; the content of the extending contract includes, but not limits to, the personal data of the contractor and the investor, the investing amount, the payment date of the investing amount, the liquidated damage, the new purchasing price of the cultivating creature and the purchasing amount, the content of the original adoption contract is modified for being served as the extending contract.

Wherein, the system is connected to a public platform of the purchasing price and the harvesting status of the cultivating creature listed in the adoption contract, the cultivating adoption evaluating and managing system of the system provides a public platform of the purchasing price and the harvesting status of the cultivating creature of the adoption contract; the data source in the public platform is processed with a data collecting and managing operation with respect to a public range agreed by both parties in the adoption contract, thus an estimated model is established to allow the investor to be aware of the estimated return on investment at the first place; the device allowing the public platform to be installed includes, but not limits to, a smart phone, a tablet computer, a computer and a wearable deice; under the public range agreed by the both parties in the adoption contract, the information disclosed in the public platform includes, but not limits to, the investing amount, the purchasing price and the purchasing amount listed in the adoption contract and the profit of the adoption contract; all the people and the users are able to browse the tendency chart of the adoption cost and the estimated return through the public system so as to be served as one of the means for evaluating whether investing in the future.

Wherein, the system is connected to a purchasing platform of the adopted creature, the cultivating adoption evaluating and managing system of the system provides a public purchasing platform to allow all the people and the user to purchase the cultivating creature cultivated by the system of the present invention regarding to the adopted creature cultivated by the system of the present invention; the platform is able to be operated via a device or a program including, but not limits to, a computer browser, a computer installed program, a mobile phone application program, a mobile phone browser, a wearable device, a tablet computer application program and a tablet computer browser; the purchasing information provided by the platform includes, but not limits to, the current storage amount, the estimated future cultivating amount, the delivery means, the purchasing means and the payment means; the information required to be provided by the buyer includes, but not limits to, the personal identification data and a hard copy, the payment means, the purchasing amount, the expected delivery date and the contract information.

Wherein, the system of the present invention is connected to a modular item selecting module of targeted adoption, the contract concluding procedure module in the cultivating adoption evaluating and managing system of the system is able to guide the user to rapidly select the targeted cultivating creature, the investing amount and other issues based on the contract through the means of modular selection and according to the requirement of the user (the investor), thus the required condition of the adoption contract is able to be rapidly confirmed; the modular selecting item includes, but not limits to, the adopting farms and the units, the cultivating creature, the investing amount and the contracting party.

Wherein, the system of the present invention is connected to an automatically establishing the adoption contract and signing online system, which follows the modular item selecting module of targeted adoption of the system; after the user has finished the modular item selection, the system is able to automatically conclude the contract according to the modular item selection and the condition thereof selected by the user, and the online signing means is provided, and the contract is immediately effective after the data and the payment of the adoption contract are checked by the system or via a manual means; with the provided function, the user is able to clearly understand each item and term listed in the adoption contract under a clear and transparent situation; and all the adopting models, the targeted adoption provided by the system are able to be served as a reference for the user to accept other adoption contracts in the future.

Wherein, the system of the present invention is connected to a real time monitoring the adoption and calculating the estimated profit module, the profit returning module of the system allows the user to real time monitor the current cultivating status of the cultivating creature in the adopted cultivating farm with the exclusive identifying code through the real time cultivating images, or analyze the current data of the cultivating creature with an identifying means (including but not limiting to the image identifying means), the current status includes, but not limits to, the appearance of the cultivating creature, the weight of the cultivating creature, the color of the cultivating creature, the size of the cultivating creature, the catgut of the cultivating creature and the activity of the cultivating creature, so as to report the adoption evaluation and the real time profit (the purchasing price of the cultivating creature) and the estimated profit to the adopter.

Wherein, the system of the present invention is connected to a contract integrating and dividing module, the contract concluding procedure module of the cultivating adoption evaluating and managing system of the system provides a service of integrating and dividing the concluded contract; with this function, the user is able to integrate to form a new contract or divide to form a new contract with respect to the agreed content and condition listed in the original contract, the agreed content and condition include, but not limit to, the adopted farm, the unit, the selection of the cultivating creature, the equipment, the time and the range; with the contract being integrated, the user is able to relief the load of monitoring the adopting profits and statuses in a plurality of contracts; with the contract being divided, the contract is able to be divided by the user so as to transfer the divided contract to other user (for example: in a situation of transferring to a child of the user, and the user being the customer of the system).

Wherein, the system of the present invention is connected to an Image Blockchain Technic (IBT) module, the system is able to make a data chain for monitoring to harvesting through the IBT composed of an artificial internet of things (AIoT), the image identification and a blockchain; the record is able to be prevented from being falsified through recording the whole cultivating process via the image identification, and the blockchain is used for storing data; with the IBT provided by the present invention, the data and the record is able to be prevented from being falsified or faked, and the tracking and identifying mechanism is formed through the blockchain, thus the cultivating creature is able to be protected from being stolen and taken by people with bad intentions to illegally deal or sale.

Wherein, the system of the present invention is connected to an equipment buyout and buyback contracting mechanism module, the system provides the equipment buyout and buyback contracting mechanism to the user; with the adoption confirming system of the cultivating adoption evaluating and managing system, the user is allowed to select the cultivating equipment including, but not limiting to, a feeding machine, an automatic observing net and a water quality monitoring instrument; after the buyout contract is concluded and signed by the user, the user honors the contract and pays the payment, an authorized person arranges the follow-up matters after the system receives the payment; according to the contract terminating, rescinding and assigning module, after the equipment buyout contract has been honored, the system synchronously arranges an authorized person to buy the equipment with the price listed in the contract on a specified date if an equipment buyback date is listed in the contract.

Advantages achieved by the present invention comparing to the prior arts are as follows. The system includes the cultivating adoption evaluating and managing system, the profit returning module, the contract terminating, rescinding and assigning module; the cultivating adoption evaluating and managing system includes, but not limits to, the adoption confirming system, the cultivating data and harvesting database and the contract database; the adoption confirming system includes, but not limits to, the adoption reporting evaluating procedure module and the contract concluding procedure module; the adoption reporting evaluating procedure module is connected to the adoption buying proposing module; the contract conforming procedure module is connected to the profit returning module; the adoption confirming system is connected to the contract terminating, rescinding and assigning module for allowing the contract to be rescinded or assigned in advance; the profit returning module is connected to the contract terminating, rescinding and assigning module after providing the purchasing amount and money in whole adoption contract; as such, the user applies for the adoption offer (subscribe) and provides the personal data and identification and the financial statement, then the user is allowed to select the cultivating farm or the cultivating creature available to be adopted and finishes the contract signing process; after the contract is concluded, the user is allowed to enter the profit returning module to get the production profit or sharing listed in the contract; after the contract target has achieved or the contract has to be rescinded due to other factors, the contract would be transferred to the contract terminating, rescinding and assigning module for terminating or rescinding the contract; accordingly, more investing capital can be founded in an easier manner, and the investing and communicating channel can be established, and the purchasing price in the market and the profit statuses of both parties can be obtained in any desired time for the investing party and the cultivating party for increasing the market transparency; as such, the applicable range in the industry can be greatly increased and features of non-obvious and novel are provided.

### BRIEF DESCRIPTION OF THE DRAWINGS

FIG. 1 is a structural schematic view according to the present invention;

FIG. 2 is a flowchart showing the adoption reporting evaluating according to the present invention;

FIG. 3 is a flowchart showing the contract concluding according to the present invention;

FIG. 4 is a flowchart showing the profit paying according to the present invention;

FIG. 5 is a structural schematic view showing FIG. 1 being provided with the return on investment estimating system of the cultivating farm, the evaluating system for adoption contract extension, the public platform of the purchasing price and the harvesting status of the cultivating creature listed in the adoption contract and the purchasing platform of the adopted creature according to the present invention; and

FIG. 6 is a structural schematic view showing FIG. 5 being provided with the modular item selecting module of targeted adoption, the automatically establishing the adoption contract and signing online system, the real time monitoring the adoption and calculating the estimated profit module, the contract integrating and dividing module, the Image Blockchain Technic (IBT) module and the equipment buyout and buyback contracting mechanism module according to the present invention.

### BRIEF DESCRIPTION OF CODES

1000: System
10: Adoption buying proposing module
1: Cultivating adoption evaluating and managing system
11: Adoption confirming system
111: Adoption reporting evaluating procedure module
1111: Cultivating data and harvesting database
112: Contract concluding procedure module
1121: Contract database
2: Profit returning module
21: Real time profit calculating module
22: Profit paying procedure module
3: Contract terminating, rescinding and assigning module
4: Return on investment estimating system of the cultivating farm
5: Evaluating system for adoption contract extension
6: Public platform of the purchasing price and the harvesting status of the cultivating creature listed in the adoption contract
7: Purchasing platform of the adopted creature
8: Other functions
81: Modular item selecting module of targeted adoption
82: Automatically establishing the adoption contract and signing online system
83: Real time monitoring the adoption and calculating the estimated profit module
84: Contract integrating and dividing module
85: Image Blockchain Technic (IBT) module
86: Equipment buyout and buyback contracting mechanism module

### DETAILED DESCRIPTION OF THE PREFERRED EMBODIMENT

One preferred embodiment of the present invention will be described with reference to the drawings for illustrating the structural assembly, the technical means and the functions to be achieved by the present invention; and the actual ratios and the arrangement of components shall not be limited by the ratios and the arrangement of components in the provided figures.

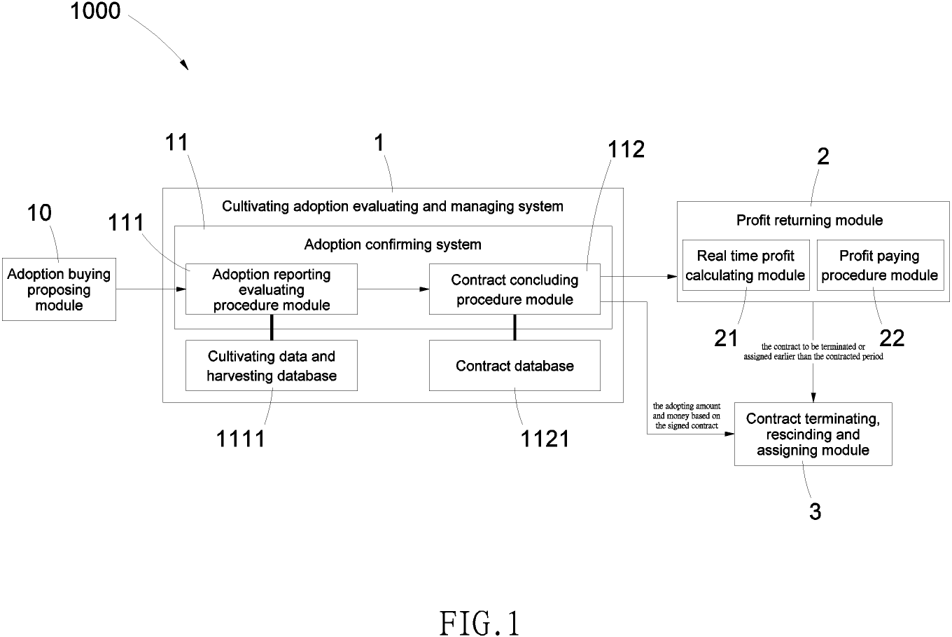

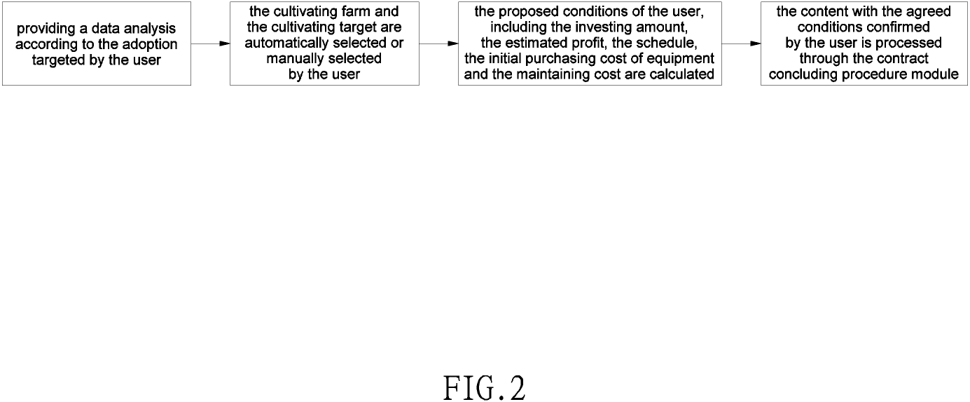

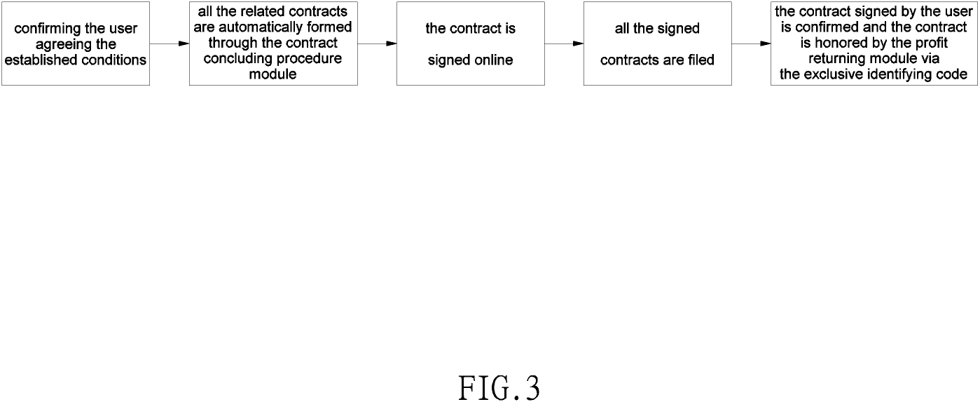

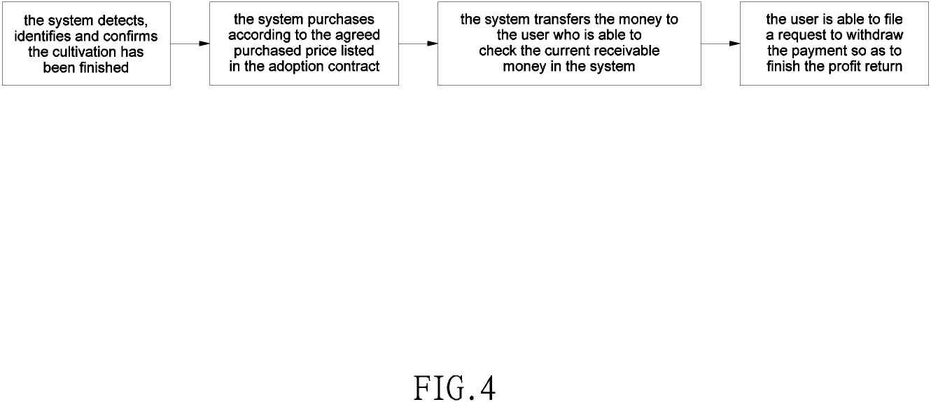

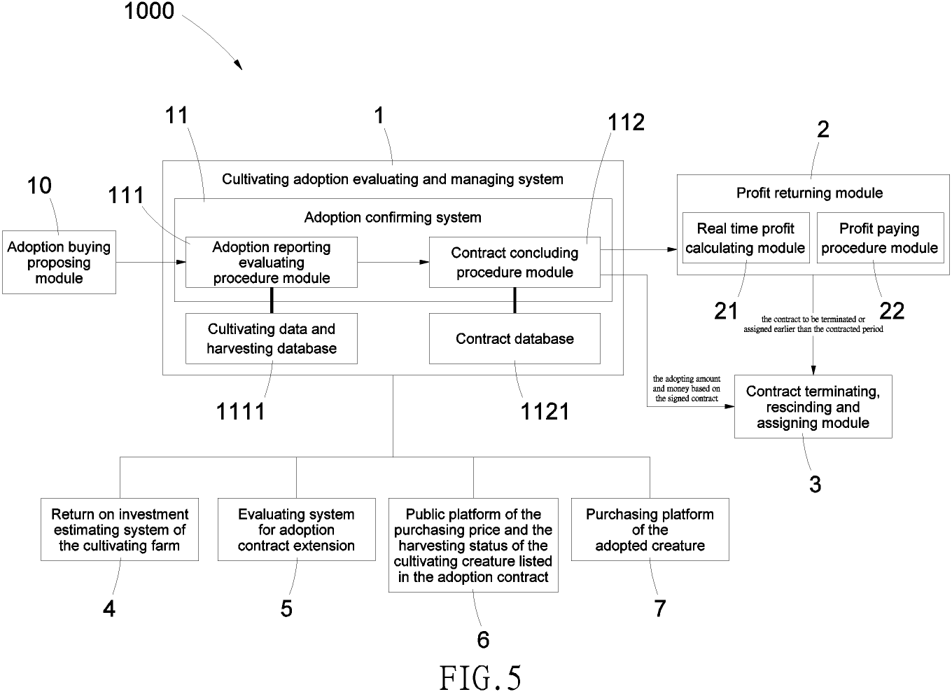

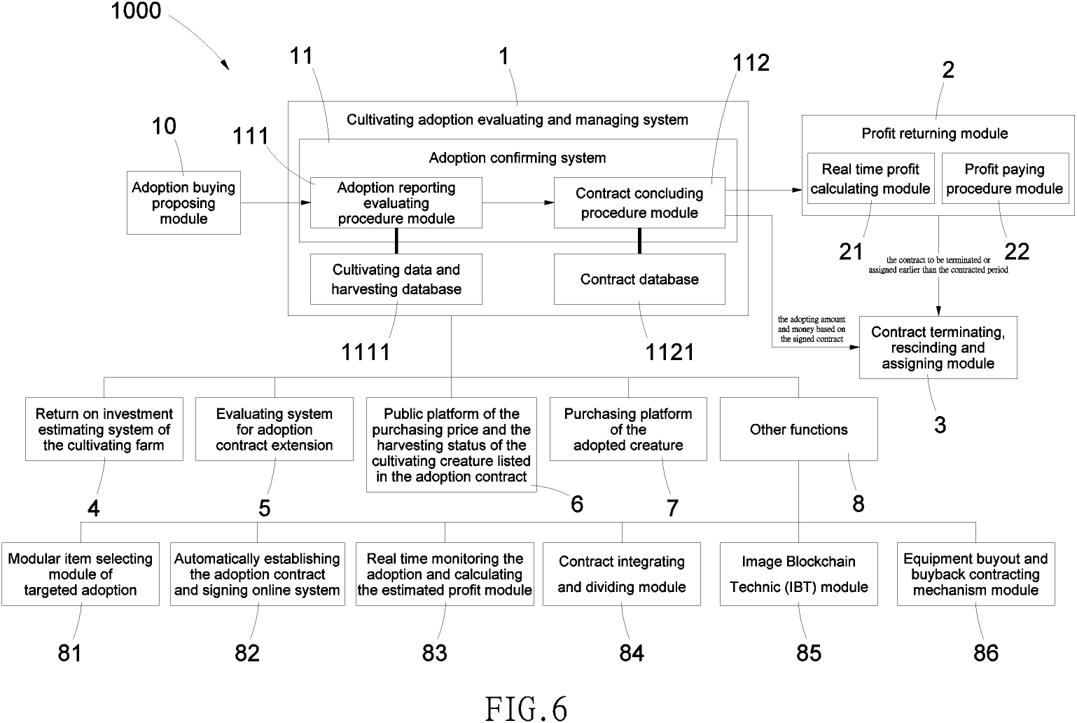

Please refer from FIG. 1 to FIG. 6, wherein FIG. 1 is a structural schematic view according to the present invention; FIG. 2 is a flowchart showing the adoption reporting evaluating according to the present invention; FIG. 3 is a flowchart showing the contract concluding according to the present invention; FIG. 4 is a flowchart showing the profit paying according to the present invention; FIG. 5 is a structural schematic view showing FIG. 1 being provided with the return on investment estimating system of the cultivating farm, the evaluating system for adoption contract extension, the public platform of the purchasing price and the harvesting status of the cultivating creature listed in the adoption contract and the purchasing platform of the adopted creature according to the present invention; and FIG. 6 is a structural schematic view showing FIG. 5 being provided with the modular item selecting module of targeted adoption, the automatically establishing the adoption contract and signing online system, the real time monitoring the adoption and calculating the estimated profit module, the contract integrating and dividing module, the Image Blockchain Technic (IBT) module and the equipment buyout and buyback contracting mechanism module according to the present invention. According to one preferred embodiment, the present invention provides an integrating system for evaluating and managing cultivation and targeted adoption 1000, which includes a cultivating adoption evaluating and managing system 1, a profit returning module 2, a contract terminating, rescinding and assigning module 3. The cultivating adoption evaluating and managing system 1 includes, but not limits to, an adoption confirming system 11, a cultivating data and harvesting database 1111, a contract database 1121; the adoption confirming system 11 includes, but not limits to, an adoption reporting evaluating procedure module 111, a contract concluding procedure module 112. The cultivating adoption evaluating and managing system 1 is to provide an adoption buying proposing module 10 to a user for concluding the contract and signing online, and the signed contract is stored in the system; the cultivating data and harvesting database 1111 is connected to the adoption reporting evaluating procedure module 111, the contract database 1121 is connected to the contract concluding procedure module 112, and the adoption reporting evaluating procedure module 111 is connected to the adoption buying proposing module 10. The proposing data provided by the adoption buying proposing module 10 includes, but not limits to, an adopted farm code, an adopted cropper or creature, an invested amount and other related documents; the contract concluding procedure module 112 of the adoption confirming system 11 is connected to the profit returning module 2; the adoption confirming system 11 allowing the contract to be terminated or assigned earlier than the contracted period is connected to the contract terminating, rescinding and assigning module 3, and the profit returning module 2 providing the adopting amount and money based on the signed contract is connected to the contract terminating, rescinding and assigning module 3 (as shown in FIG. 1).

According to the present invention, the adoption buying proposing module 10 is a procedure of data submitting and checking via the system end regarding to the adopted target and the investing budget of the user (an investor) before buying the adopting offer; the data provided by the user includes, but not limits to, the adopting farm code, the target selection of adopted cropper and creature, the investing amount, and the personal or related financial statements; and the system 1000 of the present invention may work with an image identifying process and an removing the manual inputting data submitted by the user.

According to the present invention, the cultivating adoption evaluating and managing system 1 is to offer the adoption buying proposing module 10 to the user for concluding the contract and signing online, and the signed contract is stored in the system; the adoption confirming system 11 is used for automatically or allowing the user to select the cultivating farm and the cultivating target (for example shrimps or fishes) through the adoption reporting evaluating procedure module 111 of the system 1000 of the present invention with respect to the data provided by the user who accepts the adoption buying proposing module 10; and with respect to content provided by the user including, but not limiting to, the investing amount, the estimated profit, the schedule, the initial purchasing cost for equipment and the maintaining cost; after the user confirms the agreed contents, the contract concluding procedure module 112 is used for automatically forming the cultivating farm adopting offer and all the related contracts between the user and the system, and the user is allowed to sign the contract and other documents online; the condition for concluding the contract includes, but not limits to, the contracting party, the personal data of investor, the investing amount, the payment day of investing capital, the liquidated damage, the purchasing price and the purchasing amount of the cultivating creature; the contract includes, but not limits to, an adoption contract, a rental contract, an escrow contract and a purchasing contract; after the contract is concluded, an exclusive identifying code of the contract is provided by the system to allow the cultivating creature in the cultivating farm to be tracked according to the identifying code so as to be purchased by the system after the harvest.

The cultivating data and harvesting database 1111 is used for allowing the system to calculate the data source of the estimated profit of the adoption of the user; the data content includes, but not limits to, all the historical purchasing prices of the adopted cropper, the harvesting amount and the market demand; and the contract database 1121 is a database stored with all the signed contracts and links the related data; the content and the category of the contract database 1121 includes, but not limits to, the signed contract and the content thereof (the content including, but not limiting to, the identifying code of the contract, the effecting time of the contract, the terminating time of the contract, the personal data related to the contract, the contracted target of the cultivating creature, and the contract owner), the user data, and the current status of the contract and the executing status thereof.

Please refer to FIG. 2, according to the present invention, the adoption reporting evaluating procedure module 111 is used for providing a data analysis according to the adoption targeted by the user, and the cultivating farm and the cultivating target are automatically selected or manually selected by the user, and the proposed conditions of the user, including the investing amount, the estimated profit, the schedule, the initial purchasing cost of equipment and the maintaining cost are calculated; lastly the content with the agreed conditions confirmed by the user is processed through the contract concluding procedure module 112.

Please refer to FIG. 3, according to the present invention, all the related contracts are automatically formed through the contract concluding procedure module 112 after confirming the user agreeing the established conditions; and the contract is signed online; all the signed contracts are filed; lastly the contract signed by the user is confirmed and the contract is honored by the profit returning module 2 via the exclusive identifying code.

According to the present invention, the profit returning module 2 is that after the user gets the official adoption contract and has the module of getting profit source; the profit returning module 2 includes, but not limits to, a real time profit calculating module 21, a profit paying procedure module 22; the real time profit calculating module 21 is to calculate the current estimated profit to the cultivating creature in the system including, but not limiting to, the real time dealing price of the adopted cropper or creature, the negotiated price in the adoption contract and the harvesting amount according to the existing adoption contract; the profit paying procedure module 2 is to pay the money to the user who owns the adoption contract after the cultivating creature in the adoption contract has been cultivated and the system purchases and pays the purchasing price listed in the contract, then the money is paid to the user through the system 1000 of the present invention; the payment method includes, but not limits to, banking transfer, third-party payment, cash, mobile payment, electric payment; the profit returning module 2 includes both of the historical payment records and all the received payment records which the user is able to inquire in the system with respect to the contract at any time.

Please refer to FIG. 4, according to the present invention, the profit paying procedure module 22 is that the system purchases according to the agreed purchased price listed in the adoption contract after the system detects, identifies and confirms the cultivation has been finished; then the system transfers the money to the user who is able to check the current receivable money in the system; lastly the user is able to file a request to withdraw the payment so as to finish the profit return.

In the contract terminating, rescinding and assigning module 3 according to the present invention, the contract terminating, rescinding and assigning module 3 refers to that after the purchasing amount or price according to the contract has been honored, the contract is terminated or rescinded, the right of managing the cultivating farm is back to the system, a module of providing other users or the previous user who had the adoption contract to propose the adoption; the contract includes, but not limits to, the adoption contract, the rental contract, the escrow contract and the purchasing contract; the contract terminating, rescinding and assigning module 3 is to process actions including, but not limiting to, terminating, rescinding and assigning the contract with respect to conditions and ranges agreed by both parties involved in the contract.

Extending applications of the present invention are as follows:
According to the present invention, the system 1000 is connected to a return on investment estimating system of the cultivating farm 4, the system 1000 processes a price evaluation to the price related data of the cultivating creature through the adoption reporting evaluating procedure module 111 of the cultivating adoption evaluating and managing system 1 for serving as an analysis of the estimated return on investment which can be provided to the potential customer as a reference data before investing; the data source analyzed by the system includes, but not limits to, the weight of the cultivating creature, the color of the cultivating creature, the size of the cultivating creature, the activity of the cultivating creature, the health of the cultivating creature, the catgut of the cultivating creature, the growing status of the cultivating creature, the cultivating cost, the cultivating successful rate, the cost of the cultivating equipment and the environmental factors; an integrated model of return on investment is established based on the above-mentioned data, and the obtained estimated data is stored in the cultivating data and harvesting database 1111 as a reference for potential customer.
According to the present invention, the system 1000 is connected to an evaluating system for adoption contract extension 5; the system 1000 is able to automatically provide a new contract with the current reasonable market purchasing price to the contract which is able to be terminated or rescinded according to the contract terminating, rescinding and assigning module 3, the contract is provided to the user as an extending contract, so that the profit to the user can be closer to the market purchasing price, thus any one of the user or the system can be prevented from losing profit; the content of the extending contract includes, but not limits to, the personal data of the contractor and the investor, the investing amount, the payment date of the investing amount, the liquidated damage, the new purchasing price of the cultivating creature and the purchasing amount, the content of the original adoption contract is modified for being served as the extending contract.
According to the present invention, the system 1000 is connected to a public platform of the purchasing price and the harvesting status of the cultivating creature listed in the adoption contract 6, the cultivating adoption evaluating and managing system 1 of the system 1000 provides a public platform of the purchasing price and the harvesting status of the cultivating creature of the adoption contract; the data source in the public platform is processed with a data collecting and managing operation with respect to a public range agreed by both parties in the adoption contract, thus an estimated model can be established to allow the investor to be aware of the estimated return on investment at the first place; the device allowing the public platform to be installed includes, but not limits to, a smart phone, a tablet computer, a computer and a wearable deice; under the public range agreed by the both parties in the adoption contract, the information disclosed in the public platform includes, but not limits to, the investing amount, the purchasing price and the purchasing amount listed in the adoption contract and the profit of the adoption contract; all the people and the user can browse the tendency chart of the adoption cost and the estimated return through the public system so as to be served as one of the means for evaluating whether investing in the future.
According to the present invention, the system 1000 is connected to a purchasing platform of the adopted creature 7, the cultivating adoption evaluating and managing system 1 of the system 1000 provides a public purchasing platform to allow all the people and the user to purchase the cultivating creature cultivated by the system 1000 of the present invention regarding to the adopted creature cultivated by the system 1000 of the present invention; the platform can be operated via a device or a program including, but not limits to, a computer browser, a computer installed program, a mobile phone application program, a mobile phone browser, a wearable device, a tablet computer application program and a tablet computer browser. The purchasing information provided by the platform includes, but not limits to, the current storage amount, the estimated future cultivating amount, the delivery means, the purchasing means and the payment means. The information required to be provided by the buyer includes, but not limits to, the personal identification data and a hard copy, the payment means, the purchasing amount, the expected delivery date and the contract information.

Other functions 8 provided by the present invention are as follows.
1. Modular selecting item of the targeted adoption: the system 1000 of the present invention is connected to a modular item selecting module of targeted adoption 81, the contract concluding procedure module 112 in the cultivating adoption evaluating and managing system 1 of the system 1000 is able to guide the user to rapidly select the targeted cultivating creature, the investing amount and other issues based on the contract through the means of modular selection and according to the requirement of the user (the investor), thus the required condition of the adoption contract can be rapidly confirmed. The modular selecting item includes, but not limits to, the adopting farms and the units, the cultivating creature, the investing amount and the contracting party.
2. Automatically establishing the adoption contract and signing online: the system 1000 of the present invention is connected to an automatically establishing the adoption contract and signing online system 82, which follows the modular item selecting module of targeted adoption 81 of the system 1000 of the present invention; after the user has finished the modular item selection, the system is able to automatically conclude the contract according to the modular item selection and the condition thereof selected by the user, and the online signing means is provided, and the contract is immediately effective after the data and the payment of the adoption contract are checked by the system or via a manual means; with the provided function, the user is able to clearly understand each item and term listed in the adoption contract under a clear and transparent situation; and all the adopting models, the targeted adoption provided by the system can be served as a reference for the user to accept other adoption contracts in the future.
3. Real time monitoring the adoption and calculating the estimated profit: the system 1000 of the present invention is connected to a real time monitoring the adoption and calculating the estimated profit module 83, the profit returning module 2 of the system 1000 allows the user to real time monitor the current cultivating status of the cultivating creature in the adopted cultivating farm with the exclusive identifying code through the real time cultivating images, or analyze the current data of the cultivating creature with an identifying means (including but not limiting to the image identifying means), the current status includes, but not limits to, the appearance of the cultivating creature, the weight of the cultivating creature, the color of the cultivating creature, the size of the cultivating creature, the catgut of the cultivating creature and the activity of the cultivating creature, so as to report the adoption evaluation and the real time profit (the purchasing price of the cultivating creature) and the estimated profit to the adopter.
4. Integrating and dividing the contract: the system 1000 of the present invention is connected to a contract integrating and dividing module 84, the contract concluding procedure module 112 of the cultivating adoption evaluating and managing system 1 of the system 1000 provides a service of integrating and dividing the concluded contract; with this function, the user is able to integrate to form a new contract or divide to form a new contract with respect to the agreed content and condition listed in the original contract, the agreed content and condition include, but not limit to, the adopted farm, the unit, the selection of the cultivating creature, the equipment, the time and the range; with the contract being integrated, the user can relief the load of monitoring the adopting profits and statuses in a plurality of contracts. With the contract being divided, the contract can be divided by the user so as to transfer the divided contract to other user (for example: in a situation of transferring to a child of the user, and the user being the customer of the system).
5. Image Blockchain Technic (IBT): the system 1000 of the present invention is connected to an Image Blockchain Technic (IBT) module 85, the system 1000 is able to make a data chain for monitoring to harvesting through the IBT composed of an artificial internet of things (AIoT), the image identification and a blockchain; the record can be prevented from being falsified through recording the whole cultivating process via the image identification, and the blockchain can be used for storing data. With the IBT provided by the present invention, the data and the record can be prevented from being falsified or faked, and the tracking and identifying mechanism can be formed through the blockchain, thus the cultivating creature can be protected from being stolen and taken by people with bad intentions to illegally deal or sale.
6. Equipment buyout and buyback contracting mechanism: the system 1000 of the present invention is connected to an equipment buyout and buyback contracting mechanism module 86, the system 1000 provides the equipment buyout and buyback contracting mechanism to the user; with the adoption confirming system 11 of the cultivating adoption evaluating and managing system 1, the user is allowed to select the cultivating equipment including, but not limiting to, a feeding machine, an automatic observing net and a water quality monitoring instrument; after the buyout contract is concluded and signed by the user, the user honors the contract and pays the payment, an authorized person would arrange the follow-up matters after the system receives the payment; according to the contract terminating, rescinding and assigning module 3, after the equipment buyout contract has been honored, the system would synchronously arrange an authorized person to buy the equipment with the price listed in the contract on a specified date if an equipment buyback date is listed in the contract.

Advantages achieved by the present invention comparing to the prior arts are as follows.
1. In the conventional cultivating farm, a large amount of money has to be directly invested in the whole cultivating business due to the limitation of the mode of business operation for possibly entering the profit stage; as such, the person or small firm with less capital could not directly gain profit in the cultivating business; the system 1000 provided by the present invention has unitized the cultivating farm, and a certain investing amount is set for each unit to lower the minimum investing amount for individual investor, and the investor is free to adopt the affordable unit amount according to his/her financial status; meanwhile, the cultivating farm is defined as a single field according to the system 1000 of the present invention, so that the system 1000 of the present invention is also able to divide the single field into a plurality of cultivating farms to which a certain investing amount is set.
2. In the conventional cultivating farm, a large amount of money has to be invested as previously mentioned, and the contract clause includes the purchasing price which has already been set when the contract is signed, thus the purchasing price is fixed and could not be changed; as such, the purchasing price could not correspond to the real purchasing price in the market, and the contract would not be modified to set the new purchasing price, so there may be a situation of the purchasing price and the market price being greatly different in the process of honoring the contract, a negative affection of only one of the investing party or the cultivating party enjoying the profit would happen if the purchasing price is greatly different from the market price; with the contract concluding procedure module 112 of cultivating adoption evaluating and managing system 1 of the system 1000 provided by the present invention, before any adoption contract is concluded, the latest purchasing price in the market is served as a base price for drafting the contract, thus the differentiation between the purchasing price listed in the contract and the purchasing price in the market can be reduced to the minimum, the fluctuation of purchasing price in the market is able to be reflected in the latest adoption contract to more align with the market dynamic trend.

The technical field of the present invention: the cultivating fishery, the management system; and at least characterizes in: 1. cultivating adoption evaluating and managing system; 2. profit returning module; 3. return on investment estimating system of the cultivating farm; 4. public platform of the purchasing price and the harvesting status of the cultivating creature listed in the adoption contract; 5. purchasing platform of the adopted creature: establishing the adoption contract and contract signing system, real time monitoring the adoption. According to the system 1000 of the present invention, the user has to firstly apply for the adoption offer (subscribe) and provide the personal data, then the user is allowed to register in the cultivating adoption evaluating and managing system 1 after the system 1000 confirms the identification and the financial statement, the user is allowed to select the cultivating farm or the cultivating creature available to be adopted and finishes the contract signing process; after the contract is concluded, the user is allowed to enter the profit returning module 2 to get the production profit or sharing listed in the contract; after the contract target has achieved or the contract has to be rescinded due to other factors, the contract would be transferred to the contract terminating, rescinding and assigning module 3 for terminating or rescinding the contract, and the whole adoption and profit procedure is complete; with the system 1000 provided by the present invention, the cultivating industry can be assisted to have more investing capital in an easier manner, and an investing and communicating channel can be established for the foreign investing party, and an automatic solution is provided to the large amount of the adoption contracts, the procedure of the contract drafting to the contract signing can be processed online for establishing the filing operation; the purchasing price in the market and the profit statuses of both parties can be obtained in any desired time for the investing party and the cultivating party for increasing the market transparency; accordingly, the system 1000 of the present invention is able to achieve a goal of establishing the investing channel for the cultivating industry and also achieve an objective of allowing the cultivating industry to be transparent at the same time.

According to the present invention, the system 1000 includes the cultivating adoption evaluating and managing system 1, the profit returning module 2, the contract terminating, rescinding and assigning module 3; the cultivating adoption evaluating and managing system 1 includes, but not limits to, the adoption confirming system 11, the cultivating data and harvesting database 1111 and the contract database 1121; the adoption confirming system 11 includes, but not limits to, the adoption reporting evaluating procedure module 111 and the contract concluding procedure module 112; the adoption reporting evaluating procedure module 111 is connected to the adoption buying proposing module 10; the contract conforming procedure module 112 is connected to the profit returning module 2; the adoption confirming system 11 is connected to the contract terminating, rescinding and assigning module 3 for allowing the contract to be rescinded or assigned in advance; the profit returning module 2 is connected to the contract terminating, rescinding and assigning module 3 after providing the purchasing amount and money in whole adoption contract; as such, the user applies for the adoption offer (subscribe) and provide the personal data and identification and the financial statement, then the user is allowed to select the cultivating farm or the cultivating creature available to be adopted and finishes the contract signing process; after the contract is concluded, the user is allowed to enter the profit returning module 2 to get the production profit or sharing listed in the contract; after the contract target has achieved or the contract has to be rescinded due to other factors, the contract would be transferred to the contract terminating, rescinding and assigning module 3 for terminating or rescinding the contract; accordingly, more investing capital can be founded in an easier manner, and the investing and communicating channel can be established, and the purchasing price in the market and the profit statuses of both parties can be obtained in any desired time for the investing party and the cultivating party for increasing the market transparency; as such, the applicable range in the industry can be greatly increased and features of non-obvious and novel are provided.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. An integrating system for evaluating and managing cultivation and targeted adoption, comprising:
an adoption buying proposing module for a data submitting and checking procedure regarding to an adopted target and an investing budget before buying an adopting offer;
a cultivating adoption evaluating and managing system, communicated with the adoption buying proposing module, for concluding an adoption contract, signing online and storing the signed adoption contract, the cultivating adoption evaluating and managing system comprising an adoption confirming system allowing the adoption contract to be terminated or assigned earlier than the contracted period, a cultivating data and harvesting database, and a contract database, wherein the cultivating data and harvesting database is connected to the adoption reporting evaluating procedure module for allowing the cultivating adoption evaluating and managing system to calculate the data source of the estimated profit of the adoption of the user, and the contract database is connected to the contract concluding procedure module for storing with all the signed adoption contracts and links the related data, wherein the adoption confirming system includes an adoption reporting evaluating procedure module connected to the adoption buying proposing module, and a contract concluding procedure module, wherein the adoption reporting evaluating procedure module selects a cultivating farm and a cultivating target with respect to the data provided by the user, and the contract concluding procedure module forms a cultivating farm adopting offer and all the related adoption contracts;
a profit returning module, connected to the contract concluding procedure module and the contract terminating, rescinding and assigning module, for providing the adopting amount and money based on the signed adoption contract, the profit returning module comprising a real time profit calculating module for calculating the current estimated profit to the cultivating creature in the system, and a profit paying procedure module for paying the money to the user who owns the adoption contract after the cultivating creature in the adoption contract has been cultivated; and
a contract terminating, rescinding and assigning module, connected to the adoption confirming system for terminating, rescinding and assigning the adoption contract with respect to conditions and ranges agreed by parties involved in the adoption contract;
wherein the cultivating adoption evaluating and managing system divides the cultivating farm into a plurality of divided cultivating farms such that each divided cultivating farm becomes the cultivating target, and before any adoption contract is concluded, a latest purchasing price in the market is served as a base price for drafting the adoption contract whereby the differentiation between the purchasing price listed in the adoption contract and the latest purchasing price in the market can be reduced to the minimum.

2. The integrating system for evaluating and managing cultivation and targeted adoption as claimed in claim 1, further connected to a return on investment estimating system of the cultivating farm, wherein the return on investment estimating system processes a price evaluation to the price related data of the cultivating creature through the adoption reporting evaluating procedure module of the cultivating adoption evaluating and managing system for serving as an analysis of the estimated return on investment which is able to be provided to the potential customer as a reference data before investing, and establishes an integrated model of return on investment based on the above-mentioned data, and the obtained estimated data is stored in the cultivating data and harvesting database as a reference for potential customer .

3. The integrating system for evaluating and managing cultivation and targeted adoption as claimed in claim 1, further connected to an evaluating system for adoption contract extension; wherein the evaluating system automatically provides a new contract with the current reasonable market purchasing price to the new contract which is able to be terminated or rescinded according to the contract terminating, rescinding and assigning module, and the new contract is provided to the user as an extending contract, so that the profit to the user is closer to the market purchasing price, for preventing from losing profit .

4. The integrating system for evaluating and managing cultivation and targeted adoption as claimed in claim 1, further connected to a public platform of the purchasing price and the harvesting status of the cultivating creature listed in the adoption contract, wherein the cultivating adoption evaluating and managing system provides a public platform of the purchasing price and the harvesting status of the cultivating creature of the adoption contract, the data source in the public platform is processed with a data collecting and managing operation with respect to a public range agreed by both parties in the adoption contract, thus an estimated model is established to allow the investor to be aware of the estimated return on investment at the first place, and the public platform is installed into a device.

5. The integrating system for evaluating and managing cultivation and targeted adoption as claimed in claim 1, further connected to a purchasing platform of the adopted creature, wherein the cultivating adoption evaluating and managing system of the system provides a public purchasing platform to allow the user to purchase the cultivating creature cultivated by the integrating system regarding to the adopted creature cultivated by the integrating system and the platform is able to be operated via a device or a program.

6. The integrating system for evaluating and managing cultivation and targeted adoption as claimed in claim 1, further connected to a modular item selecting module of targeted adoption, wherein the contract concluding procedure module in the cultivating adoption evaluating and managing system of the integrating system guides the user to rapidly select the targeted cultivating creature, and the investing amount based on the adoption contract through the means of modular selection and according to the requirement of the use, thus the required condition of the adoption contract is rapidly confirmed party.

7. The integrating system for evaluating and managing cultivation and targeted adoption as claimed in claim 1, further connected to an automatically establishing the adoption contract and signing online system, which follows the modular item selecting module of targeted adoption for automatically concluding the adoption contract according to the modular item selection and the condition thereof selected by the user, and providing the online signing means, wherein the adoption contract is immediately effective after the data and the payment of the adoption contract are checked by the integrating system.

8. The integrating system for evaluating and managing cultivation and targeted adoption as claimed in claim 1, further connected to a real time monitoring the adoption and calculating the estimated profit module, wherein the profit returning module allows the user to real time monitor the current cultivating status of the cultivating creature in the adopted cultivating farm with the exclusive identifying code through real time cultivating images, or analyze the current data of the cultivating creature with an identifying means.

9. The integrating system for evaluating and managing cultivation and targeted adoption as claimed in claim 1, further connected to a contract integrating and dividing module, wherein the contract concluding procedure module of the cultivating adoption evaluating and managing system provides a service of integrating and dividing the adoption contract for forming a first new contract or divide to form a second new contract with respect to the agreed content and condition listed in the adoption contrac system).

10. The integrating system for evaluating and managing cultivation and targeted adoption as claimed in claim 1, further connected to an Image Blockchain Technic (IBT) module, for making a data chain for monitoring to harvesting through the IBT composed of an artificial internet of things (AIoT), the image identification and a blockchain, wherein the record is able to be prevented from being falsified through recording the whole cultivating process via the image identification, and the blockchain is used for storing data.

11. The integrating system for evaluating and managing cultivation and targeted adoption as claimed in claim 1, further connected to an equipment buyout and buyback contracting mechanism module for providing the equipment buyout and buyback contracting mechanism to the user.
